(19) United States
(12) Patent Application Publication
(10) Pub. No.: US 2004/0182228 A1
(43) Pub. Date: Sep. 23, 2004

(54) Method for teaching individual parts in a musical ensemble

(76) Inventor: H. Carlton Brett, Westport, CT (US)

Correspondence Address: WILLIAM C. CRUTCHER, MCCORMICK, PAULDING & HUBER, LLP, 185 ASYLUM STREET, CITY PLACE II, 18TH FLOOR, HARTFORD, CT, 06103-4102, US

(21) Appl. No.: 10/639,888

(22) Filed: Aug. 13, 2003

Related U.S. Application Data
(60) Provisional application No. 60/456,480, filed on Mar. 21, 2003.

(51) Int. Cl. G10H 1/36; G10H 7/00

(52) U.S. Cl. 84/612

(57) ABSTRACT

Individual parts in a chorus are taught by making digital recordings of one or more individual performers singing their parts in the chorus. The digital recordings are re-recorded on user media such as a CD at the normal tempo and at one or more slower tempos without loss of the original pitch. The CD is played to learn the individual part by hearing it stand out in the chorus at the true pitch, but at slow speed. The method is equally applicable for instrumental parts in an orchestra.

### CROSS REFERENCE TO RELATED APPLICATIONS

This application claims priority of provisional application Serial No. 60/656480 filed Mar. 21, 2003.

### BACKGROUND OF THE INVENTION

This invention relates to the teaching of musical parts performed as part of a musical ensemble. More particularly, the invention relates to the creation of a learning aid for delivering separate, clear, varied speed, recorded presentations for teaching a single instrument or voice part of a musical work in the context of that work's complete finished performance.

It is known in the prior art to mix and synchronize pre-recorded music tracks with songs by a performer singing or playing the same song, using digital audio workstations. It is also known to play pre-recorded music for performance by Karaoke singers, who might not know the song very well, but who nevertheless attempt to perform with the pre-recorded musical group playing at normal tempo.

The present invention seeks to teach difficult individual parts of a musical work for later performance by a musical ensemble.

Very few singers and instrumentalists can read a piece of music for the first time and sing or play it back perfectly. The norm is to begin by reading the music slowly, by themselves usually in a private place, and thus begin to learn the music. This process may take a lot of repeats or few repeats depending on the skills of the musician. Furthermore, if the singer is required to sing in a foreign language in which the singer is not proficient, the learning process can take considerable time. Learning in such isolation, however, establishes a context quite different from a performance context and when the musician enters the new context of performing with all the added sounds, changing speeds (or tempi) and surroundings there is always a period of adjustment required to perform to the maximum of previously learned ability.

Digital recording is quite different in nature from the older analog recording on records or tapes, wherein the pitch level of a musical work-recorded at a pre-selected recording speed varies with the speed of playback of the recorded work. For the purpose of this patent application, “normal pitch level” denotes that the musical work is heard in the proper key corresponding to the key in which it was written. Digital recording translates samples or slices of the musical sound into a fixed numeric value in binary code. That value will not change on playback no matter at what speed it is played back. Thus, if a musical phrase is recorded at 10,000 samples per minute, but played back at 6,000 samples per minute, the mathematical value represented by a binary number remains the same and thus the normal pitch level of the sound does not change. This capability differs from analog-based recording technology where the speed of playback determines the pitch level of the recorded sounds.

By employing such digital recording a musical work can be recorded in performance and played back at the recorded speed, or half speed or twice speed, without a drop or rise in the music's pitch, but the music's speed, or tempo, can be selected at will depending on capabilities of the playback hardware.

Such digitally based information can be captured and stored on all types of digital storage media (disks, tape, static cards, single machine and i-net servers, etc.) capable of recording and retaining digital information.

It would be desirable to be able to learn an individual musical part in context of hearing the approximate sounds of the complete finished performance but at a slow tempo. This would make the learning process much easier and almost eliminate the disorientation when all musicians come together for the performance. Similar advantages would exist when new music is being written or existing music revised.

It would also be desirable to make available a teaching tool, such as CD, DVD disk, or the internet in a *.wav, *.mp3, or other format, which the learning musician could acquire and play back at a preferred speed as needed. Further, the learning tool could be produced at several different tempi. For example, a CD or DVD disk can contain the same musical work at several tempi, such as normal performance tempo, two thirds of normal performance tempo and one half of normal performance tempo.

Accordingly one object of the present invention is to provide a method for teaching an individual part to be performed in a musical ensemble.

Another object of the invention is to provide a teaching aid for use of an individual performer to learn his or her part in a musical ensemble.

Still another object is to utilize digital recording, data manipulation and varied speed playback technology to teach an individual part in a choral or orchestral work.

Still another object of the invention is to utilize digital recording to teach songs sung in a foreign language or to perform songs tailored to learning a foreign language via use of songs in that language.

### SUMMARY OF THE INVENTION

Briefly stated the invention is practiced by making a first digital recording of a portion of a musical work by an individual performer, mixing it with a second digital recording of the same portion of the musical work by a musical ensemble to provide a third digital recording, and playing back the third digital recording at different pre-selected tempi to teach the individual part for the portion of the musical work. Teaching aids for individual performers are provided by making recordings of the varied tempi playbacks on conventional user media.

In its preferred form, the invention is a method for teaching individuals to perform individual parts of a work to be performed by a musical ensemble at a selected normal tempo and corresponding normal pitch level, the method comprising:

(a) providing multiple track digital recording apparatus with a plurality of microphones, a digital audio workstation having a digital recording track for each respective microphone, track mixing controls, speed controls and output recording means for making a plurality of digital recordings on user playback media,

(b) making a digital recording on a first digital recording track of said musical ensemble performing at least a portion of the work,

(c) simultaneously making a digital recording on a second digital recording track of an individual performing an individual part of the portion of the work,

(d) combining the first and second tracks so as to enable the individual part to be distinguishable to a listener,

(e) adjusting the speed of the combined tracks to a selectable teaching tempo slower than the normal tempo, while maintaining the normal pitch level,

(f) making a first playback recording of the combined tracks at the normal tempo on the user playback media, and

(g) making a second playback recording of the third track at the teaching tempo on the user playback media.

The combined tracks may either be a third digital recording used to make monaural playback recordings at different tempi, or may be stereo digital recordings used to make stereo playback recordings at different tempi.

More than one individual part can be recorded, more than one teaching tempo playback recording can be made, and the recordings may be monaural, stereo or multiple track, all of the conventional digital recording, mixing and playback techniques being useful in the practice of the present invention.

### DRAWINGS

The invention will be better understood by reference to the following specification, taken in connection with the accompanying drawings, in which:

FIG. 1 is a simplified block diagram of the invention in its simplest form used a pre-recorded musical work,

FIG. 2 is a simplified block diagram of a preferred form of the invention recording selected individual parts during performance of a musical work by an ensemble, and

FIG. 3 is a simplified block diagram of the invention, using stereo recording.

### DETAILED DESCRIPTION

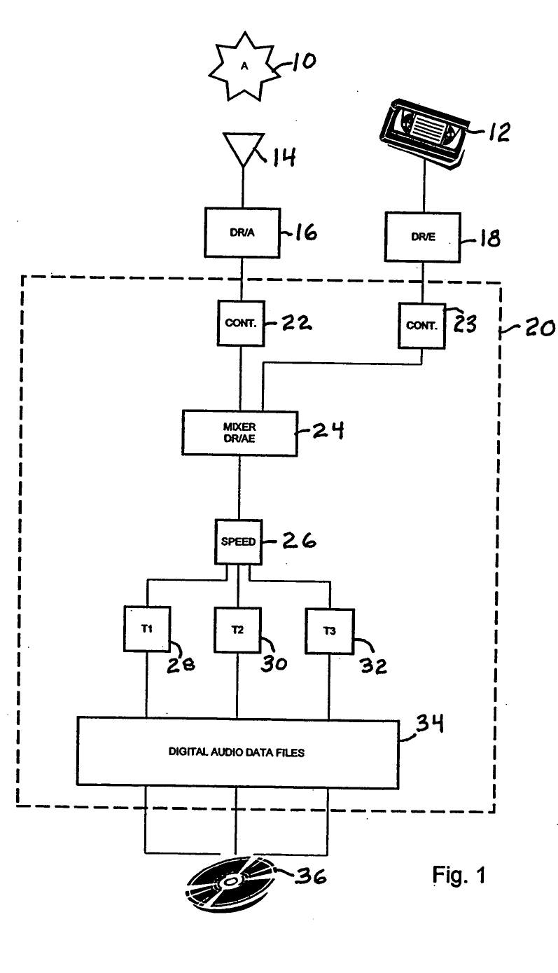

Referring now to FIG. 1 of the drawing, the invention is depicted in its simplest form. An individual performer, who is familiar with an individual part in a musical work, whether this be a singing part in a chorus, or an instrumental part in an orchestra, is depicted at reference number 10. In the example shown in FIG. 1, this is an alto singer “A”. The musical work is performed in this case as a pre-recorded work played on a tape recorder 12, the output being available to singer 10. The singer performs the alto part at a normal tempo into a microphone 14, which is connected either by a cable or through a wireless link to a conventional digital recorder 16. A first digital recording DR/A is made of the alto part using the conventional apparatus to convert the analog sound waves to a coded digital file on any suitable recording medium. The recording process involves sampling the audio signal arriving at the digital recorder at a selected sampling rate and converting the sampled signals to a binary coded form, using standard formats known to those skilled in the audio recording industry.

Simultaneously with the recording of the alto part, the entire musical ensemble is recorded on a digital recorder 18 as a second digital recording DR/E. The first and second digital recordings DR/A and DR/E are introduced into a digital audio workstation 20 depicted within the dashed line rectangle, a suitable workstation for this purpose being a Fairlight MFX 3+unit. Other similar digital audio workstations are commercially available, and perform similar functions to those to be described. The particular apparatus used is capable of digital data manipulation, and may also perform the recording functions of digital recorders 16, 18 to initially capture the audio data. The file of the first digital recording of the alto part is manipulated by a control unit 22, while the second digital recording is separately manipulated by a control unit 23. The digital recordings are merged in a mixer 24 to create a new third digital recording DR/AE. By appropriate manipulation of variables such as gain, a balanced digital sound recording is obtained wherein the alto part can be distinguished clearly in the context of the entire chorus or musical ensemble performing the work at a normal tempo.

The third digital recording is introduced into a speed control 26, in which the selected sampling rate at which the work was recorded can be changed to a different sampling rate. It is a feature of digital recording that the bit value of each successive sample determines the pitch level of that sample. When the recording is played back with longer intervals between samples than those of the original recording, the tempo changes, but the pitch level of each sample does not change. Therefore the music is heard at a slower tempo without distortion or lowering of the pitch level that occurs in an analog recording when the payback speed is reduced.

In accordance with the present invention a sound track T1 is made of the third digital recording at normal tempo. Then the sampling speed is lowered by means of the speed control 26 and a sound track T2 is made of the same recording, but at a lower or teaching tempo. The teaching tempo is selected according to the difficulty of the individual part to be learned. For, example, the teaching tempo may be selected to be 80% of the normal tempo. It should be noted in passing that the digital sampling of a voice with excessive vibrato may result in undesirable excursions from the normal pitch level. This can be handled by selecting a voice with less vibrato, or by re-recording the part singer at a slower speed.

In the example shown a third even slower audio track T3 is created by using an even slower sampling rate. The successively created sound track files T1, T2, and T3 are represented in the block diagram by reference numbers 28, 30, 32, respectively. These tracks are used to create a single file of successive tracks T1, T2 and T3 stored in a master media output unit 34 for subsequent manufacture of user media, such as CD, DVD, tape or other media for audio playback. In the example shown a CD master tape would be made, which is used by conventional manufacturing methods to mass-produce CD's such as the one depicted at 36.

While the invention as depicted in its simplest form in FIG. 1 uses a pre-recorded work for making the digital recording of the ensemble, this may require permission or copyright clearance to use the prerecorded work. The preferred form of the invention prepares the digital recording of the musical ensemble at the time the work is performed and also may include the simultaneous preparation of the digital recordings of more than one performer. In this way, more than one output recording may be prepared, one for each singing part or instrument, to be used by that singing part or instrument to learn the part at a slower tempo.

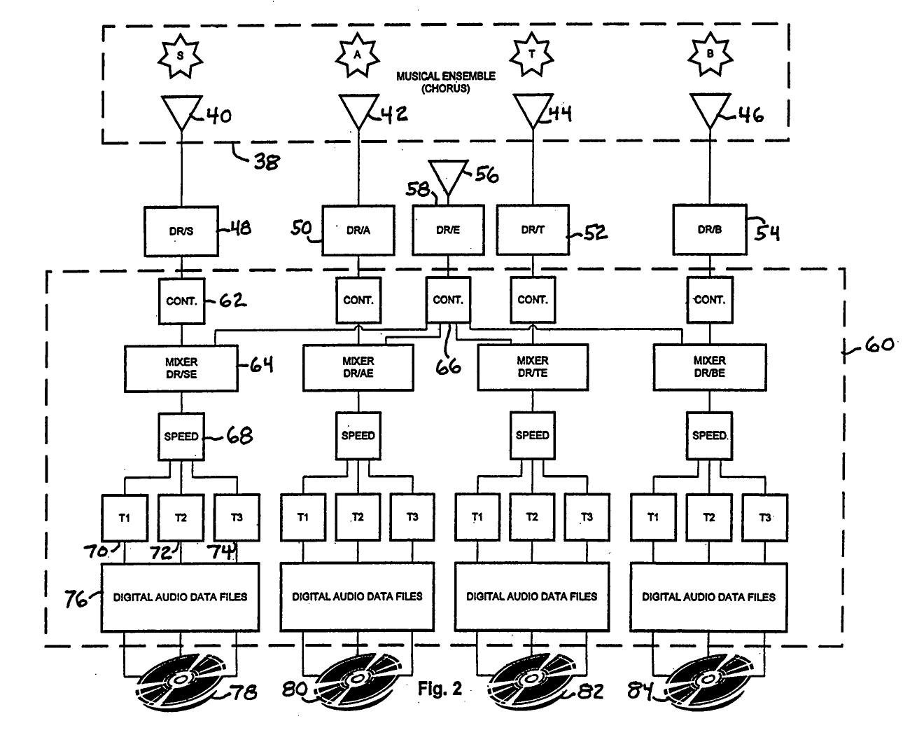

Referring to FIG. 2 of the drawing, a musical ensemble is indicated by the dashed line enclosure 38. In this case the ensemble 38 is a chorus, with or without musical accompaniment, performing a portion of a musical work having soprano, alto and bass parts. Individual singers “S”, “A”, “T” and “B” who know the parts well and have suitable voices are equipped with microphones 40, 42, 44, and 46 respectively. These may be lapel-type microphones and are connected to digital recorders 48, 50, 52, and 54 respectively either by wiring cables or wireless links.

One or more microphones, represented by the single microphone 56 in the drawing, are placed to record the sound of the combined chorus and/or accompaniment on a digital recorder 58. Stereophonic recording may also be used in lieu of the monaural setup depicted. The digital recordings of the four parts are designated as DR/S, DR/A/, DR/T, and DR/B, while the digital recording of the ensemble is designed DR/E. The digital recordings are introduced into a digital audio workstation 60 depicted within the dashed line rectangle, a suitable workstation for this purpose being a Fairlight MFX 3+ unit, as before. The handling of the digital recordings by the digital workstation is the same as previously described in connection with the embodiment shown in FIG. 1, except that four output recordings are made rather than one. Therefore, only the preparation of the soprano teaching recording will be described, the preparation of the output recordings for teaching the alto, tenor and bass parts being identical.

A control station 62 is connected to input the soprano digital recording DS/S into a mixer 64. Another control station 66 receives digital recording DR/E and introduces it into the mixer 64, where a third digital recording DR/SE is produced.

By appropriate manipulation of variables such as gain, using the control station 62, a balanced digital sound recording is obtained wherein the soprano part can be distinguished clearly in the context of the entire chorus performing the work at a normal tempo.

The third digital recording is introduced into a speed control 68, in which the selected sampling rate at which the work was recorded can be changed to a different sampling rate.

In accordance with the present invention a sound track T1 is made of the third digital recording at normal tempo. Then the sampling speed is lowered by means of the speed control 68 and a sound track T2 is made of the same recording, but at a lower or teaching tempo. The teaching tempo is selected according to the difficulty of the individual part to be learned. For, example, the teaching tempo may be selected to be 80% of the normal tempo. Next, a third slower audio track T3 is created by using a slower sampling rate. The successively created sound track files T1, T2, and T3 are represented in the block diagram by reference numbers 70, 72, and 74, respectively. These tracks are used to create audio data files of successive tracks T1, T2 and T3 stored in a master media output unit 76 for subsequent manufacture of user media, such as CD, DVD, tape or other media for audio playback. The audio data files could also be used to produce *.wav, *.mp3, or other formats for use over the internet. In the example shown a CD master tape would be made, which is used by conventional manufacturing methods to mass-produce CD's such as the one for teaching the soprano part that is depicted at 78.

The other three parts are balanced and mixed with the ensemble recording to provide files at different tempi, as previously described in connection with the soprano part. These are used to make output recordings of the other three parts on sequential or adjacent tracks at normal, slow and slower tempi. These recordings are depicted as CD's 80, 82 and 84 for the alto, tenor and bass parts respectively.

The same method as described above would be used for recording an orchestral work, by selecting instrumental parts such as first violin, cello, flute, etc. and providing those instruments with microphones to record their parts at normal tempo along with the full orchestra. Similarly combined orchestra and chorus could be recorded, along with selected difficult parts in either chorus or orchestra or both.

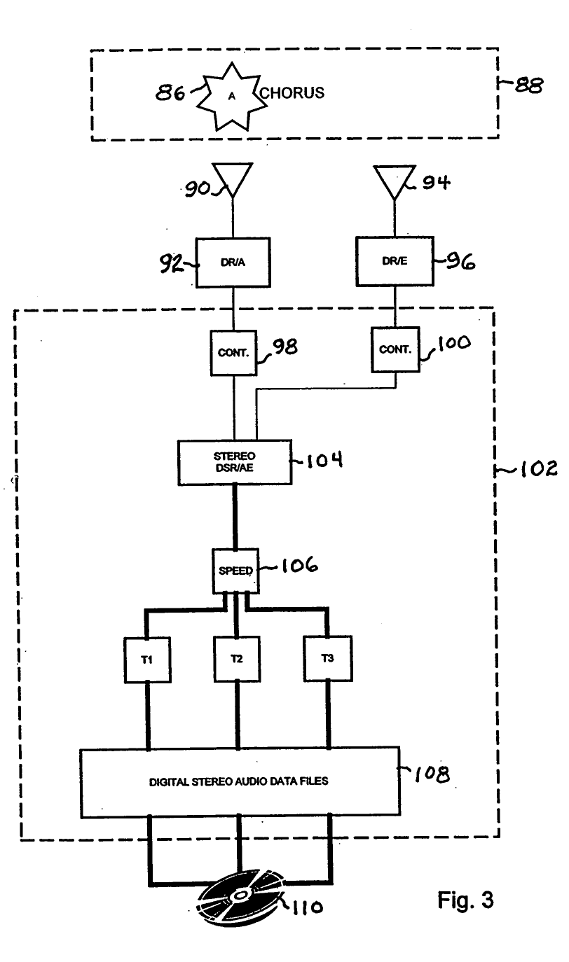

Stereo recording could also be employed using the same technique as taught by the present invention. FIG. 3 illustrates the use of stereo recording a singer 86 singing the alto part A in a chorus 88. A left hand stereo microphone 90 makes a digital recording DR/A for the left hand track on a recorder 92. A right hand microphone 94 makes a digital recording DR/E of the full chorus or musical ensemble on a recorder 96. The left and right hand stereo recordings are input to control devices 98, 100, either at the time of performance or subsequently in a digital audio work station 102. The left and right tracks are synchronized and converted to a digital stereo recording DSR/AE as to adjacent tracks in unit 104. The two adjacent stereo tracks are represented by heavy lines in the FIG. 3 block diagram. Through use of a speed control 106, stereo tracks T1, T2 and T3 are created at normal, slow, and slower tempi and stored as digital stereo audio data files in a master media output unit 108. Thereafter, the files are used to create user media such as a stereo CD shown at 110.

By using stereo techniques, a user CD may be created which can be used by the listener to change the balance of the chorus against the part singer, as well as to play the recording at slower tempi.

Any number of teaching tempi may be selected and any suitable teaching tempo may be selected as well, depending on the difficulty of the part and complexity of the musical work. All of the work or only a portion thereof may be recorded.

In use, the output media are used by individual performers or groups learning a part, by playing them back and performing along with the recorded sounds, first at slower finally at the normal tempo.

Other modifications will occur to those skilled in the art and it is desired to secure in the appended claims all such modifications as fall within the true spirit and scope of the invention.

1. Method for teaching an individual to perform an individual part of a work to be performed by a musical ensemble at a selected normal tempo and corresponding normal pitch level, the method comprising:
(a) making a first digital recording of an individual part of at least a portion of a musical work by an individual performer,
(b) making a second digital recording of the same portion of the musical work by a musical ensemble,
(c) combining said first digital recording with said second digital recording to provide a third digital recording, and
(d) playing the third digital recording at a teaching tempo lower than said normal tempo at said normal pitch level.

2. Method according to claim 1, including the additional steps of:
(e) providing user playback media,
(f) recording the third digital recording at said normal tempo at said normal pitch level on user playback media, and
(g) recording the third digital recording at said teaching tempo at said normal pitch level on said user playback media.

3. Method according to claim 1, wherein said steps (a) and (b) are performed simultaneously.

4. Method according to claim 1, wherein said individual part is sung.

5. Method according to claim 1, wherein said individual part is played on an instrument.

6. Method according to claim 1, wherein said individual part is in a language foreign to said individual.

7. Method according to claim 1, wherein step (c) comprises playing the third digital recording at more than one teaching tempo.

8. Method according to claim 1, wherein steps (a) and (b) comprise recording said individual part and said musical ensemble onto first and second stereo tracks, and wherein step (c) comprises combining said stereo tracks into a digital stereo recording.

9. Method for teaching individuals to perform different individual parts of a work to be performed by a musical ensemble at a selected normal tempo and corresponding normal pitch level, the method comprising:
(a) making a plurality of first digital recordings of respective individual parts of at least a portion of a musical work by a plurality of individual performers,
(b) providing a second digital recording of the same portion of the musical work by a musical ensemble,
(c) mixing said plurality of digital recordings with said second digital recording to provide a plurality of third digital recordings respectively, each of said third digital recordings combining an individual part with said musical ensemble, and
(d) recording the third digital recordings on user playback media at a teaching tempo lower than said normal tempo to teach said respective individual parts for said portion of the musical work.

10. Method for teaching individuals to perform individual parts of a work to be performed by a musical ensemble at a selected normal tempo and corresponding normal pitch level, the method comprising:
(a) providing multiple track digital recording apparatus with a plurality of microphones, a digital audio workstation having a digital recording track for each respective microphone, track mixing controls, speed controls and output recording means for making a plurality of digital recordings on user playback media,
(b) making a digital recording on a first digital recording track of said musical ensemble performing at least a portion of the work,
(c) simultaneously making a digital recording on a second digital recording track of an individual performing an individual part of the portion of the work,
(d) combining the first and second tracks so as to enable the individual part to be distinguishable to a listener,
(e) adjusting the speed of the combined tracks to a selected teaching tempo slower than the normal tempo, while maintaining the normal pitch level,
(f) making a first playback recording of the combined tracks at the normal tempo on the user playback media, and
(g) making a second playback recording of the combined tracks at the teaching tempo on the user playback media.

11. Method according to claim 10, wherein said individual part is sung.

12. Method according to claim 10, wherein said individual part is played on an instrument.

13. Method according to claim 10, further including: (h) making a third playback recording of the third track at an additional selected teaching tempo slower than said normal tempo.

14. Method according to claim 10, wherein said individual part is in a language foreign to the individual performing said individual part.

15. User playback media comprising a CD of at least said first and second playback recordings made by the method of claim 10.

16. User playback media comprising a DVD disk of at least said first and second playback recordings made by the method of claim 10.

17. User playback media comprising a stored file accessible over the internet of at least said first and second playback recordings made by the method of claim 10.
